(19) United States
(12) Patent Application Publication
(10) Pub. No.: US 2008/0235769 A1
(43) Pub. Date: Sep. 25, 2008

(54) SYSTEM AND METHOD FOR ADAPTIVE TARPITS USING DISTRIBUTED VIRTUAL MACHINES

(76) Inventors: Stacy Purcell, Orangevale, CA (US); Hong Li, El Dorado Hills, CA (US); Tobias M. Kohlenberg, Portland, OR (US)

Correspondence Address: Molly A. McCall;Intel Corporation, c/o Intellevate, LLC, P.O. Box 52050, Minneapolis, MN, 55402, US

(21) Appl. No.: 11/689,022

(22) Filed: Mar. 21, 2007

(51) Int. Cl. G06F 7/04

(52) U.S. Cl. 726/3

(57) ABSTRACT

A system and method for adaptive tarpits using distributed virtual machines. A method in an embodiment may include determining an intrusion prevention strategy in response to a potential attack on a network. Then, based on the intrusion prevention strategy, allocating at least one virtual tarpit in the network, where the at least one virtual tarpit is implemented as a virtual machine, and the adapting the at least one virtual tarpit in the network includes one or more of suspending a virtual tarpit, resuming a suspended virtual tarpit and migrating a virtual tarpit to another virtual machine in the network. Other embodiments are described and claimed.

### BACKGROUND

A problem that has grown along with the growth of computer networks has been the surge in unauthorized or malicious access to computer systems. Such unauthorized or malicious access has been made possible by computer networks, wherein anonymous persons (or automated programs) can gain access to computer systems and cause damage to data, access to other systems, etc. One growing problem is where an intruder attempts to connect to many addresses over a computer network in order to establish a connection to a computer system using a network address. The completed connection can be used to access the corresponding computer system, and even to access other computer systems in communication with the compromised computer system.

Various approaches to detecting and preventing this form of unauthorized access to computer networks are commonly referred to as tarpits or honeypots (e.g., sticky honeypot). Here, unused and typically static network addresses of a network are monitored by a security system or security routine. The security system is programmed to recognize the unused network addresses, and treats any attempts to access these network addresses as unauthorized access attempts. An access attempt is commonly initiated by an acknowledgement request, wherein a response from an address indicates that a host is present at that address and may be vulnerable to attack. When no response is received from an address, the agent performing the unauthorized access attempt knows immediately that the address is not used, and continues to “scan” the network (e.g., probe or scan other addresses in the network).

In addition to the security system detecting an unauthorized access attempt, the security system can hold the connection, and can make the scanning computer waste time waiting for an expected response. This is where the term tarpit or honeypot come into play. When a scanning computer identifies a host and subsequently attempts to exchange messages with the host at a given network address, the security system can issue a “busy,” “wait,” or “retry” response. The scanning computer will therefore wait for a “non-busy” or “ready” message, or wait until a timeout period elapses. This can typically cause the scanning computer to wait for a period of time from a few minutes to indefinitely, depending on various factors which include the inherent capabilities of the particular implementations of the network systems by different vendors, such as different timeout periods. In addition, the scanning computer typically is halted from scanning for other computer systems on the network.

Thus, tarpits and honeypots are “special-purpose” or “fake” elements or computers in a network that act as decoys, luring in the scanning computer or potential attacker in order to detect, analyze and “sink” attack traffic. Accordingly, tarpits and honeypots should appear as normal computers to potential attackers. If not, smart attackers will avoid scanning the tarpits or honeypots. In addition, tarpits and honeypots used in many networks today are mostly static (i.e., static IP address) and not distributed due to limitations set by the number of physical machines available, network topology, network scale, etc.

### BRIEF DESCRIPTION OF THE DRAWINGS

FIG. 1 illustrates one embodiment of a system.

FIG. 2 illustrates one embodiment of a virtual platform.

FIG. 3 illustrates one embodiment of a logic flow.

FIG. 4 illustrates one embodiment of a logic flow.

### DETAILED DESCRIPTION

Various embodiments may be generally directed to a system and method for adaptive tarpits using distributed virtual machines. In an embodiment, a network is monitored for potential attacks. Once a potential attack is identified, a virtual tarpit or intrusion prevention strategy is determined. In an embodiment, the virtual tarpit strategy determines the number of virtual tarpits needed and the locations in the network to allocate the virtual tarpits in order to “trap” the attack traffics by the attacker. Each of these virtual tarpits may act as a distributed virtual machine or adaptive tarpit in that it may be suspended, resumed and/or migrated to other virtual machines located in the network. The ways in which one or more virtual tarpits adapt within the network may be based on the type or method of attack. The ability to allocate virtual tarpits at the location of choice inside a network enhances the ability to monitor, analyze and contain network attacks and malware outbreaks more accurately. Other embodiments may be described and claimed.

Various embodiments may comprise one or more elements or components. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

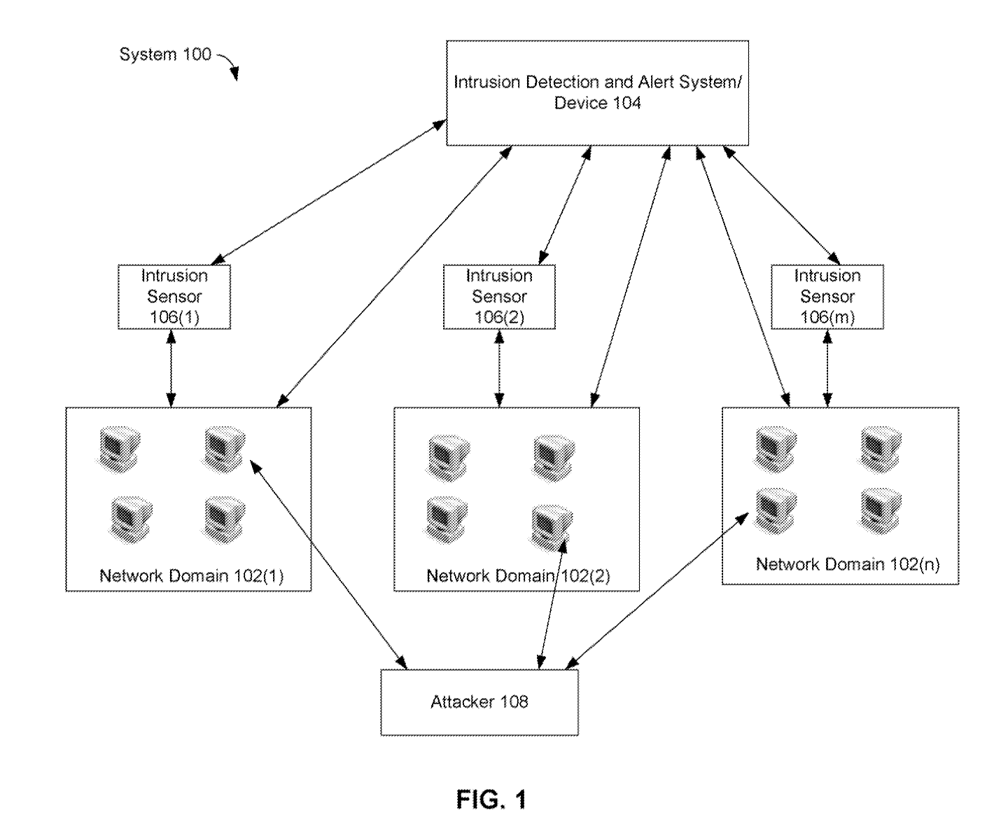

FIG. 1 illustrates one embodiment of a system 100 for adaptive tarpits using distributed virtual machines. In an embodiment, system 100 includes a network that is configured into one or more network domains 102 (102(1)-102(n), where n is any positive integer). System 100 also includes an intrusion detection and alert system or device 104 and one or more intrusion sensors 106 (106(1)-106(m), where m is any positive integer). FIG. 1 also illustrates a potential attacker 108 that is currently scanning the network.

In various embodiments, system 100 may be implemented as a wireless system, a wired system, or a combination of both. When implemented as a wireless system, system 100 may include components and interfaces suitable for communicating over a wireless shared media, such as one or more antennas, transmitters, receivers, transceivers, amplifiers, filters, control logic, and so forth. An example of wireless shared data may include portions of a wireless spectrum, such as the RF spectrum and so forth. When implemented as a wired system, system 100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

At a high level and in an embodiment, intrusion detection and alert system 104 and intrusion sensors 106 monitor network domains 102 for a potential intrusion by an agent, such as attacker 108. A potential attack may be determined if, for example, it is determined that attacker 108 is scanning the computers in one or more of network domains 102. Once a potential attack is determined, intrusion detection and alert system 104 determines a virtual tarpit strategy (i.e., an intrusion prevention strategy). In an embodiment, the virtual tarpit strategy determines the number of virtual tarpits to allocate and the location in the network for the allocated virtual tarpits in order to “trap” the attack traffics by attacker 108. Each of these virtual tarpits may be instantiated on a virtual machine adaptively in that it may be suspended, resumed and/or migrated to other virtual machines distributed across the network. As will be described next, any computer in network domains 102 may be allocated as one or more virtual tarpits.

In an embodiment, network domains 102 each include one or more computers that may be implemented via a virtual platform and thus can be a host of one or more special-purpose devices or virtual machines. One or more of these virtual machines may be instantiated as a virtual tarpit. Accordingly, as many tarpits as necessary to address an intrusion of the network by attacker 108 may be created on demand, and with these virtual machines distributed across the network the locations of the tarpits can also be strategically distributed.

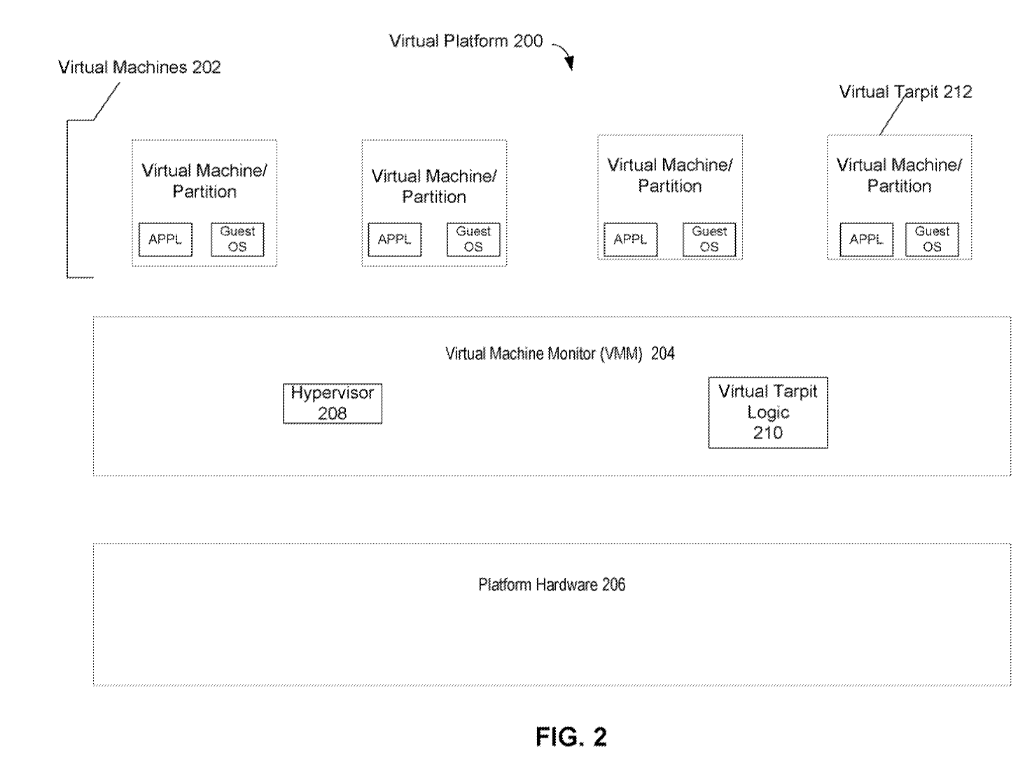

FIG. 2 illustrates an embodiment of an environment for the invention, in which some embodiments may operate. In FIG. 2, the invention is implemented via an embodiment of a virtualized platform. Referring to FIG. 2, virtual platform 200 may include one or more virtual machines or partitions 202, a virtual machine monitor (VMM) 204 and platform hardware 206. VMM 204 may include a hypervisor 208 and virtual tarpit logic 210. One or more of virtual machines 202 may be allocated as a virtual tarpit, such as virtual tarpit 212.

In general, a virtualized platform is a single physical platform that is segregated into a plurality of virtual partitions. The physical platform incorporates at least one VMM, such as VMM 204. A conventional VMM typically runs on a computer and presents to other software the abstraction of one or more virtual machines. Each virtual machine may function as a self-contained platform, running its own “guest operating system” (i.e., an operating system (OS) hosted by the VMM) and other software or applications, collectively referred to as guest software.

Processes running within a virtual machine are provided with an abstraction of some hardware resources. A hypervisor, such as hypervisor 208, provides the virtualization abstraction of computer systems underneath it. Every virtual machine assumes that it has full control over the hardware resources allocated to it. The VMM is an entity that is responsible for appropriately managing and arbitrating system resources among the virtual machines including, but not limited to, platform hardware 206 (e.g., processors, input/output (I/O) devices and memory).

In the embodiment described herein in relation to FIG. 2, a virtualized platform is partitioned and one or more of the virtual machines 202 may be allocated as virtual tarpits, such as virtual tarpit 212. Though four virtual machines/partitions are shown in FIG. 2, it is understood that any number of virtual machines/partitions may be present.

Each virtual machine 202 may include one or more applications. For example, the applications of virtual tarpit 212 may include one or more software applications that are needed to perform the necessary tasks of a virtual tarpit as determined by virtual tarpit logic 210 of VMM 204. Virtual tarpit logic 210 may be used to allocate one or more virtual tarpits, as determined by information provided via an alert from intrusion detection and alert system 104 (FIG. 1). Virtual tarpit logic 210 may also be used to distribute or adapt virtual tarpit 212 throughout the network such that virtual tarpit 212 may be suspended, resumed and/or migrated to other virtual machines located in the network.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

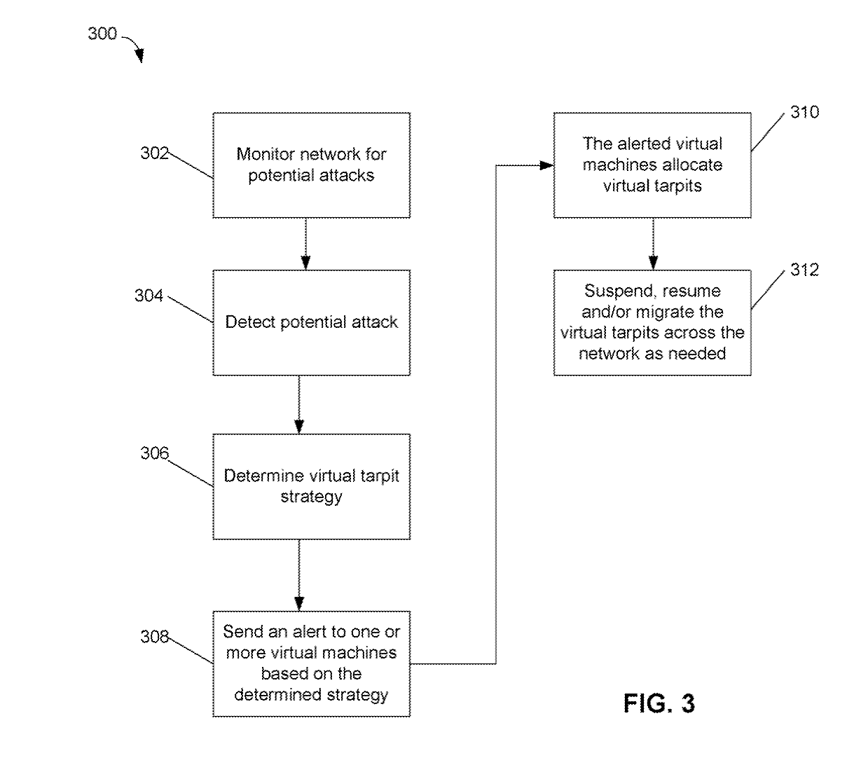

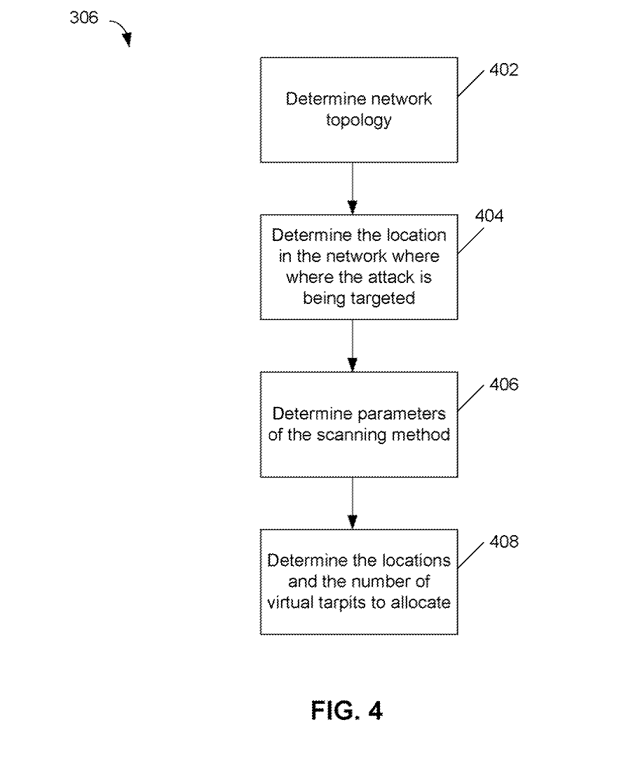

FIGS. 3 and 4 each illustrates one embodiment of a logic flow. The logic flows may be representative of the operations executed by one or more embodiments described herein.

As shown in logic flow 300 of FIG. 3, a network (such as the network comprised of network domains 102 of FIG. 1) is monitored for potential attacks via the intrusion detection and alert system and intrusion sensors (such as system 104 and sensors 106 of FIG. 1) (block 302). For example, a potential attacker (such as attacker 108 of FIG. 1) may be “scanning” the computers in the network. Here, an access attempt of the network is commonly initiated by an acknowledgement request, wherein a response from an address indicates that a host is present at that address and may be vulnerable to attack. When no response is received from an address, the attacker performing the unauthorized access attempt knows immediately that the address is not used, and continues to probe or scan other addresses in the network.

When a potential attack is detected (block 304), then the intrusion detection and alert system determines a virtual tarpit strategy (block 306). As mentioned above and in an embodiment, the virtual tarpit strategy determines the number of virtual tarpits to allocate and the locations in the network for the allocated virtual tarpits in order to “trap” the attack traffics by the attacker. Block 306 is described below in more detail with reference to FIG. 4.

Based on the determined virtual tarpit strategy, the intrusion detection and alert system creates and sends an alert to one or more computers (or virtual machines) in the network (block 308). As mentioned above, any of the computers in the network may be implemented via a virtual platform and thus can be a host of one or more virtual tarpits. Accordingly, as many tarpits as necessary to address an intrusion of the network by the attacker may be created on demand.

The alerted virtual machines allocate the virtual tarpits (block 310). As described above, virtual tarpit logic (such as logic 210 of FIG. 2) may be used to allocate one or more virtual tarpits, as determined by information provided via the alert from the intrusion detection and alert system.

The virtual tarpit logic may also be used to distribute or adapt the virtual tarpit(s) throughout the network such that the virtual tarpit(s) may be suspended, resumed and/or migrated to other virtual machines located in the network (block 312). The ways in which one or more virtual tarpits adapt within the network may be based on the type of attack.

FIG. 4 illustrates an embodiment of how the intrusion detection and alert system determines a virtual tarpit strategy (block 306 of FIG. 3). Referring to FIG. 4, the intrusion detection and alert system determines the topology of the network (block 402). The location in the network where the attack is being targeted also may be determined (block 404). The parameters of the method of scanning by the attacker may be determined (block 406). Based on one or more of the network topology, targeted attack location and scanning method parameters, the virtual tarpit strategy is determined. This includes the number of virtual tarpits needed and the locations in the network to allocate the virtual tarpits in order to “trap” the attack traffics by the attacker (block 408).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interface, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
determining an intrusion prevention strategy in response to a potential attack on a network; and
based on the intrusion prevention strategy, allocating at least one virtual tarpit in the network, wherein the at least one virtual tarpit is implemented as a virtual machine.

2. The method of claim 1, wherein the intrusion prevention strategy determines a number of virtual tarpits to allocate and a location in the network for each of the allocated virtual tarpits.

3. The method of claim 1, wherein the intrusion prevention strategy is determined based on one or more of a topology of the network, a location where the attack is being targeted in the network and one or more parameters of a method of the attack.

4. The method of claim 3, further comprising:
adapting the at least one virtual tarpit in the network based on the attack method.

5. The method of claim 4, wherein the adapting the at least one virtual tarpit in the network includes one or more of suspending a virtual tarpit, resuming a suspended virtual tarpit and migrating a virtual tarpit to another virtual machine in the network.

6. The method of claim 3, wherein the method of the attack involves scanning the network.

7. The method of claim 1, wherein the attack on the network is identified as a scanning of the network by an agent.

8. A system comprising:
an intrusion detection device to determine an intrusion prevention strategy in response to a potential attack on a network; and
at least one virtual tarpit in the network, wherein the virtual tarpit to be allocated based on the intrusion prevention strategy, and wherein the at least one virtual tarpit is implemented as a virtual machine.

9. The system of claim 8, wherein the intrusion prevention strategy to determine a number of virtual tarpits to allocate and a location in the network for each of the allocated virtual tarpits.

10. The system of claim 8, wherein the intrusion prevention strategy is determined based on one or more of a topology of the network, a location where the attack is being targeted in the network and one or more parameters of a method of the attack.

11. The system of claim 10, wherein the at least one virtual tarpit to adapt in the network based on the attack method.

12. The system of claim 11, wherein the at least one adapted virtual tarpit includes one or more of a suspended virtual tarpit, a resumed virtual tarpit after suspension and a migrated virtual tarpit to another virtual machine in the network.

13. The system of claim 10, wherein the method of the attack involves scanning the network.

14. The system of claim 8, wherein the attack on the network is identified as a scanning of the network by an agent.

15. A machine-readable medium containing instructions which, when executed by a processing system, cause the processing system to perform a method, the method comprising:
determining an intrusion prevention strategy in response to a potential attack on a network; and
based on the intrusion prevention strategy, allocating at least one virtual tarpit in the network, wherein the at least one virtual tarpit is implemented as a virtual machine.

16. The machine-readable medium of claim 15, wherein the intrusion prevention strategy determines a number of virtual tarpits to allocate and a location in the network for each of the allocated virtual tarpits.

17. The machine-readable medium of claim 15, wherein the intrusion prevention strategy is determined based on one or more of a topology of the network, a location where the attack is being targeted in the network and one or more parameters of a method of the attack.

18. The machine-readable medium of claim 17, further comprising:
adapting the at least one virtual tarpit in the network based on the attack method.

19. The machine-readable medium of claim 18, wherein the adapting the at least one virtual tarpit in the network includes one or more of suspending a virtual tarpit, resuming a suspended virtual tarpit and migrating a virtual tarpit to another virtual machine in the network.

20. The machine-readable medium of claim 17, wherein the method of the attack involves scanning the network.
